(19) United States
(12) Patent Application Publication
(10) Pub. No.: US 2005/0110456 A1
(43) Pub. Date: May 26, 2005

(54) Rechargeable battery casing having charge/discharge multiple-use jack, waterproof jack plug for the same and relay terminal therefor

(76) Inventor: Cheon Soo Jeong, Gunsan (KR)

Correspondence Address: PARK & SUTTON LLP, 3255 WILSHIRE BLVD, SUITE 1110, LOS ANGELES, CA, 90010, US

(21) Appl. No.: 10/843,153

(22) Filed: May 12, 2004

(30) Foreign Application Priority Data
Nov. 20, 2003 (KR) 10-2003-0082506

(51) Int. Cl. H02J 7/00

(52) U.S. Cl. 320/111

(57) ABSTRACT

The present invention relates to a casing in which a rechargeable battery, etc. is contained. More particularly, the present invention relates to a rechargeable battery casing having a charge/discharge multiple-use jack consisting of a single jack to easily perform the charging and discharging of the battery, and having a waterproof structure to stably maintain the performance of a product, a waterproof jack plug connected thereto and a relay terminal.

### CROSS REFERENCE RELATED TO THE INVENTION

The applicant claims and requests a foreign priority, through the Paris Convention for the Protection of Industry Property, based on a patent application filed in the Republic of Korea (South Korea) with the filing date of Nov. 20, 2004, with the application number 10-2003-0082506, by the applicant. (see the attached declaration)

### FIELD OF THE INVENTION

The present invention relates to a casing in which a rechargeable battery, etc. is contained. More particularly, the present invention relates to a rechargeable battery casing having a charge/discharge multiple-use jack consisting of a single jack to easily perform the charging and discharging of the battery, and having a waterproof structure to stably maintain the performance of a product, a waterproof jack plug connected thereto and a relay terminal.

### BACKGROUND OF THE RELATED ART

A rechargeable battery, etc. that is usually used is mounted in an electronic product as a power supply, or is built in an additional external casing having a power jack, etc. through which the power of the battery is supplied to the electronic product.

At this time, due to limited size and shape, the electronic product is usually supplied with the power of the battery from an external casing or an external power supply through a jack plug. In this case, the battery is contained within the casing and a jack code having a jack plug for discharging formed at its front end is drawn from the casing, or only an electric code for discharging is drawn from the casing without the jack plug.

In such a conventional method, in order to recharge the battery contained in the battery casing, the battery must be removed from the battery casing and then mounted in a separate charger for charging. After the completion of the recharging process, the battery has to be re-located in the battery casing. This makes a user feel inconvenient in using the battery.

Moreover, in this method, the battery casing has also to be frequently opened/closed since the battery must be frequently attached to and detached from the battery casing. For this reason, there occurs a problem in that the battery casing cannot have a waterproof structure.

Therefore, in a wet condition, components within the battery casing may rust, which contributes to shortening the lifespan of the battery, or may cause a problem in reliability of the battery.

In particular, for such a battery casing, there is a limitation of its use in that it cannot be used in products which must be used in the rain or the water.

Furthermore, an existing rechargeable battery casing has only a jack terminal for discharging (output), or a jack terminal-for charging and a jack terminal for discharging separately. Therefore, there are problems in that the battery casing is complicated in structure and is inconvenient to use.

### SUMMARY OF THE INVENTION

Accordingly, the present invention has been made in view of the above problems, and it is an object of the present invention to provide a rechargeable battery casing capable of performing both charging and discharging of a battery using a single common jack.

Another object of the present invention is to provide a chargeable battery casing having a waterproof structure.

A further another object of the present invention is to provide a waterproof jack plug that is suitable for the aforementioned rechargeable battery casing and has a waterproof structure.

### BRIEF DESCRIPTION OF THE DRAWINGS

Further objects and advantages of the invention can be more fully understood from the following detailed description taken in conjunction with the accompanying drawings in which:

FIG.1 is a perspective view illustrating a rechargeable battery casing according to the present invention;

FIG. 2 is a front view illustrating a state where the front panel of a body casing is removed according to the present invention;

FIG. 3 is a left side view illustrating a battery casing according to the present invention;

FIG. 4a is a cross-sectional view illustrating the battery casing according to the present invention, FIG. 4b is an enlarged view of an “A” portion shown in FIG. 4a, and FIG. 4c shows an exemplary modification of the “A” portion shown in FIG. 4b;

FIG. 5 shows an exemplary charger that can be connected to a charge/discharge multiple-use jack according to the present invention;

FIG. 6 is a view illustrating a main part of a waterproof jack plug according to the present invention;

FIG. 7a is a partial cross-sectional view illustrating a state where the waterproof jack plug is used according to the present invention;

FIG. 7b shows an exemplary modification of the waterproof jack plug shown in FIG. 7a according to the present invention;

FIG. 8 is a partially cut view of the body casing according to the present invention;

FIG. 9 is a diagram illustrating the basic structure of the body casing according to the present invention;

FIG. 10 is a basic circuit diagram of the body casing according to an embodiment of the present invention;

FIG. 11 is a rear view illustrating a body casing (for example, applied to a mobile phone) according to another embodiment of the present invention another;

FIG. 12 shows a state where the battery is removed from the mobile phone shown in FIG. 11;

FIG. 13 is a rear view illustrating a body casing applied to a mobile phone according to a further another embodiment of the present invention another;

FIG. 14 shows a state where the battery is removed from the mobile phone shown in FIG. 13;

FIG. 15a and FIG. 15b are a rear view and a front view of the battery shown in FIG. 13, respectively;

FIG. 16 is a cross-sectional view of the battery taken along lines “B-B” in FIG. 14;

FIG. 17 is a detailed view of a “C” portion shown in FIG. 16 and FIG. 18 is a detailed view of the “C” portion when the battery is attached;

FIG. 19a and FIG. 19b schematically show the positions of jacks in the mobile phone according to the present invention;

FIG. 20 is a rear view when the battery is removed from the mobile phone according to an embodiment of the present invention;

FIG. 21 is a perspective view of the mobile phone shown in FIG. 20;

FIG. 22 and FIG. 23 are a front view and a rear view of the battery that is attached to and detached from the mobile phone shown in FIG. 20, respectively;

FIG. 24a is a perspective view illustrating an O-ring for waterproof according to the present invention, and FIG. 24b is a perspective view of the O-ring shown in FIG. 24a, which is half cut;

FIG. 25a is a perspective view illustrating an “D” portion of the battery shown in FIG. 23 and an “E” portion corresponding to the “D” portion;

FIG. 25b is a perspective view illustrating a modification of the battery shown in FIG. 25a;

FIG. 26 to FIG. 29 are rear views illustrating a body casing of a mobile phone or a rechargeable battery according to another embodiment of the present invention;

FIG. 30 is a front view illustrating a state where the cover of a mobile phone is opened according to the present invention;

FIG. 31 is a cross-sectional view illustrating the mobile phone taken along lines “F-F” in FIG. 30;

FIG. 32 shows another example of the mobile phone to which the present invention is applied;

FIG. 33 is a cross-sectional view illustrating a interconnecting jack according to the present invention;

FIG. 34 is a perspective view illustrating the interconnecting jack shown in FIG. 33.

### DETAILED DESCRIPTION OF THE PREFERRED EMBODIMENT

The present invention will now be described in detail in connection with preferred embodiments with reference to the accompanying drawings.

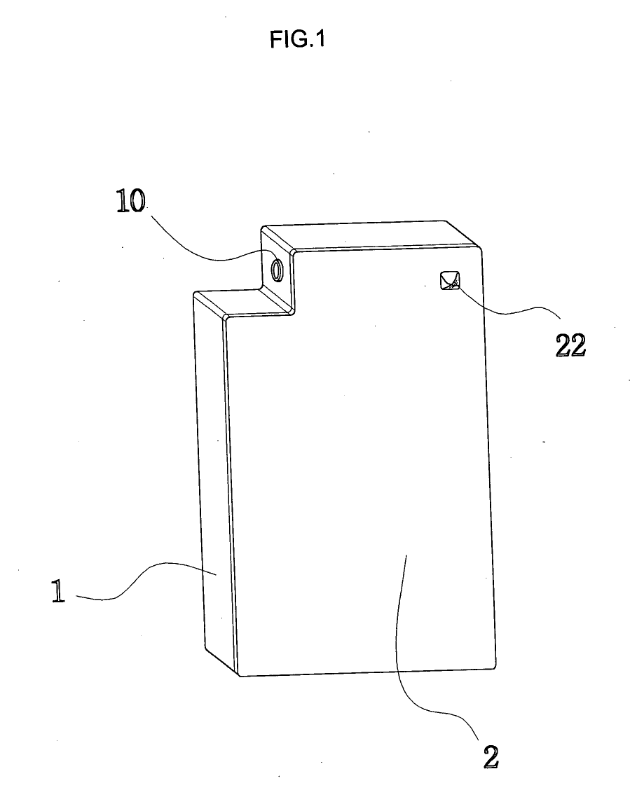

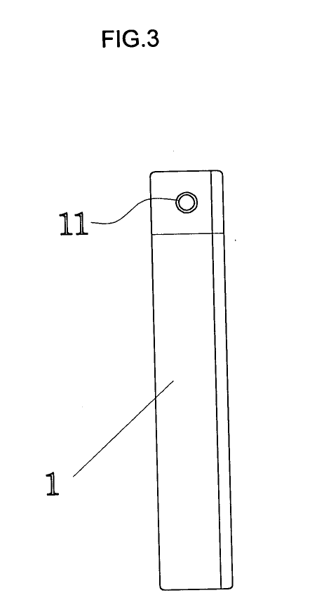

FIG. 1 to FIG. 4c shows a rechargeable battery casing having a charge/discharge multiple-use jack according to the present invention. As can be seen from the drawings, the charge/discharge multiple-use jack is disposed in the casing.

More specifically, the rechargeable battery casing having the charge/discharge multiple-use jack according to the present invention includes a body casing 1, an input/output control unit 20 disposed within the body casing and having a switching circuit, a rechargeable battery 5 located within the body casing, and an anti-overcharging unit 30 connected to the battery 5 and having an anti-overcharging circuit connected to the input/output control unit 20. In the above, the input/output control unit 20 includes a charge/discharge multiple-use jack 10 capable of performing both charging and discharging of the battery 5 as a single terminal.

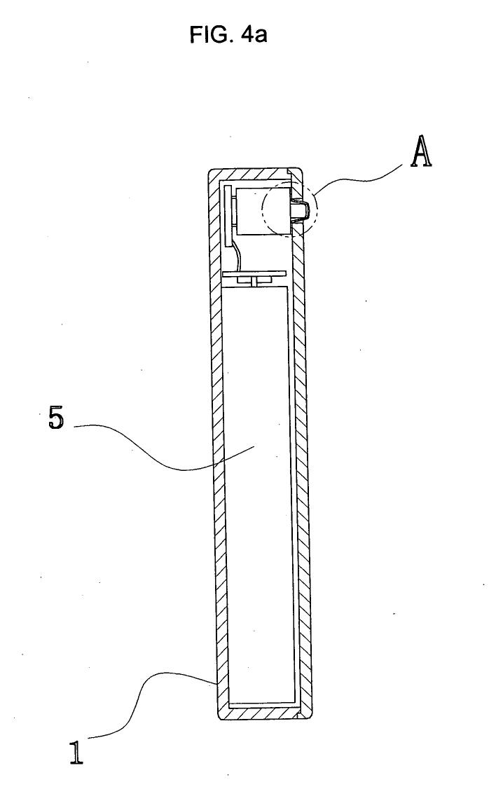

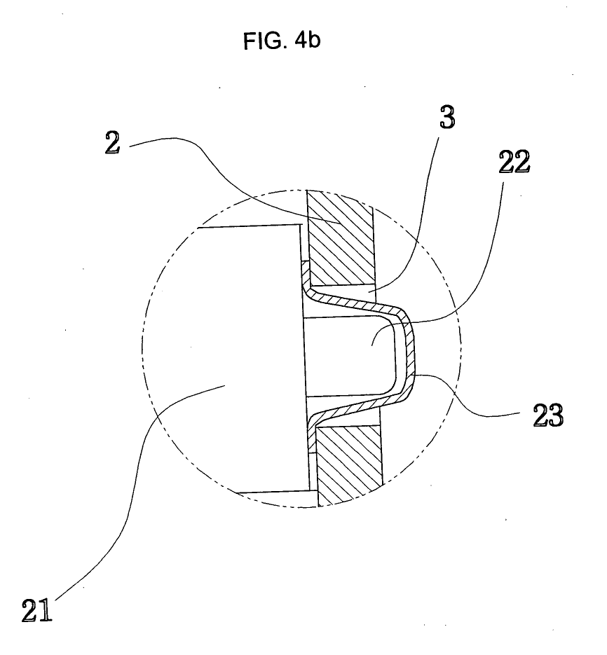

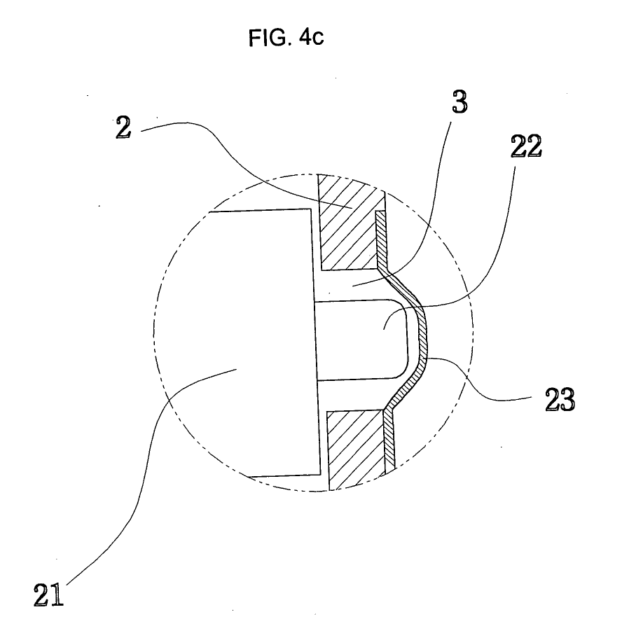

The input/output control unit 20 has a pushing switch 21 and the charge/discharge multiple-use jack 10 mounted on a printed circuit board in which a switching circuit is formed. The pushing switch 21 is formed such that a portion of a switch button 22 is projected through a button projection hole 3 formed in the body casing 1. At this time, a waterproof cap 23 for covering the top of the switch button 22 is installed. It is preferred that the waterproof cap 23 tightly seals the button projection hole 3 while resiliently pressing it (see FIG. 4).

It is preferred that a material of the waterproof cap 23 is a synthetic rubber series having a good elasticity. The edge of the waterproof cap may be firmly attached to the switch button or around the inner side of the button projection hole 3 in the body casing 1. In either casing, it is recommended that the size of the waterproof cap 23 be designed to cover the switch button 22 and also tightly seals the button projection hole 3 while resiliently pressing the hole.

The structure of the waterproof cap 23 constructed above according to the present invention can be modified like FIG. 4c. In this modified example, the waterproof cap 23 for covering and tightly sealing the projected switch button and the button projection hole is disposed at the outer side of the body casing, in the structure of FIG. 4b. As such, the waterproof cap 23 does not resiliently block the inside of the button projection hole 3 but covers and tightly seals the outside of the button projection hole 3.

Through this structure, it is possible to get rid of a danger that water may be infiltrated into the switch button 22.

A jack terminal guide hole 8 is further formed at one side (preferably, a lateral side) of the body casing 1. The front end of a jack terminal 11, which is a terminal of the charge/discharge multiple-use jack 10, is projected toward the outside through the guide hole 8. At this time, it is preferred that a space between the outer surface of the jack terminal 11 and the jack terminal guide hole 8 is tightly sealed with a filler 4 for waterproof.

By doing so, it is possible to prevent moisture from being infiltrated through the jack terminal guide hole 8.

In order to form the above structure, it is preferred that the front of the body casing 1 is additionally formed as the front plate 2, various components and a battery are contained within the front plate, the front plate 2 is covered, and the body casing 1 and the front plate 2 are then integrated through melting.

In the battery casing constructed above according to the present invention, all the components are precluded from an outer atmosphere except for the terminal hole of the jack terminal 11 in the charge/discharge multiple-use jack 10, thus accomplishing a waterproof structure. Further, the terminal hole of the jack terminal is tightly sealed as the male terminal of the jack plug is inserted into the terminal hole of the jack terminal.

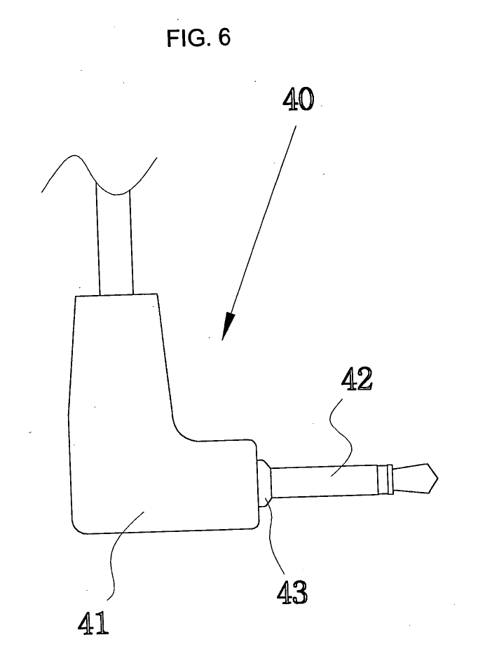

FIG. 6 to FIG. 8 illustrate the jack plug 40 for waterproof according to the present invention, which can be suitably used in the battery casing having the charge/discharge multiple-use jack according to the present invention, examples that the jack plug 40 for waterproof is used and the like.

Referring to FIG. 6 to FIG. 8, in a waterproof jack plug having a jack plug unit 40 wherein one end of an electric code is connected to a typical electrical appliance and the other end of the electric code is inserted into a jack terminal 11 of the charge/discharge multiple-use jack 10, the jack plug unit 40 includes a male terminal body 42 having a plurality of contacts formed at its one end, wherein the contacts become electrodes and the male terminal is inserted into the jack terminal, and a plug body 41 for housing the other end of the male terminal connected to the electric code of the male terminal body 42. In the above, the male terminal body 42 has a waterproof packing 43 of a resilient material formed at the outer circumferential surface thereof at its one side for blocking and tightly sealing a space between the jack terminal 11 and the male terminal body 42 when the male terminal body 42 is inserted into the jack terminal 11.

In other words, if the jack plug is inserted into the jack terminal 11, the waterproof packing 43 of the male terminal body 42 blocks the terminal hole of the jack terminal 11 while resiliently depressing the terminal hole, so that the terminal hole of the jack terminal 11 is completely sealed. Therefore, the battery casing having the charge/discharge multiple-use jack according to the present invention has a complete waterproof structure and can be thus used in the water.

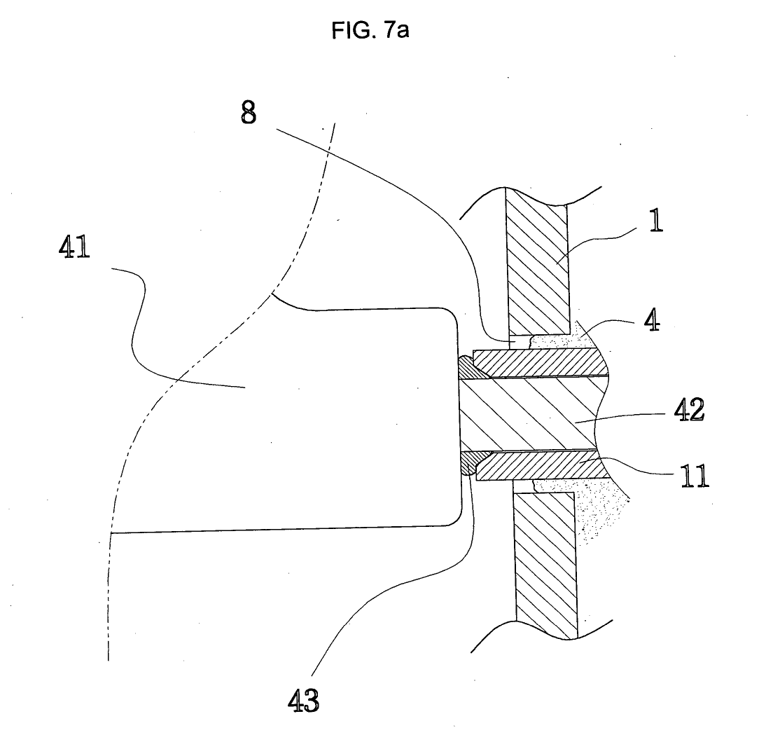

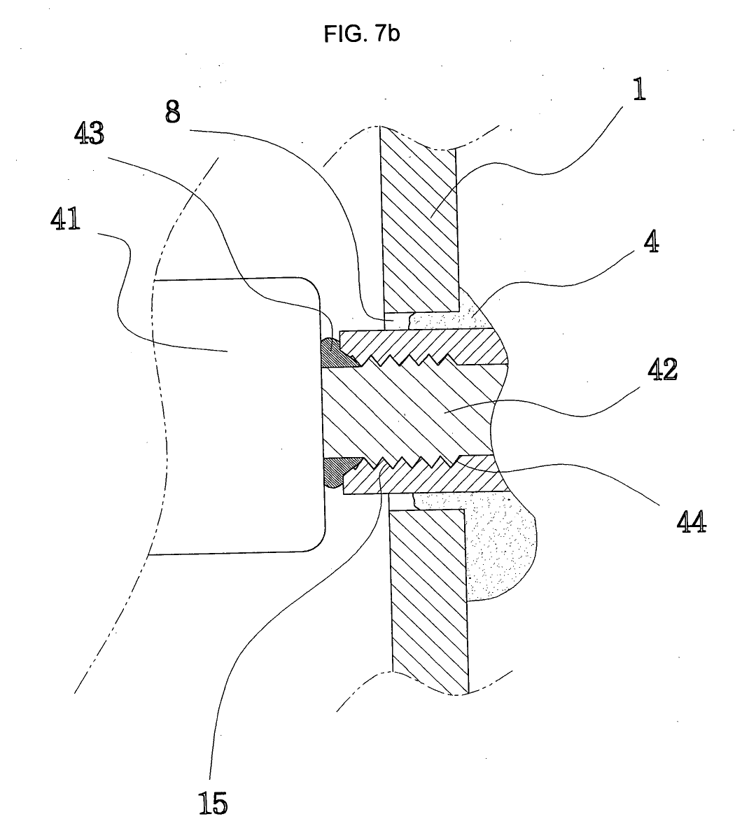

The jack plug is mechanically forcibly inserted into the jack terminal to maintain the bolt torque. However, if the water pressure is high, the bolting may be released. In preparation for this, the waterproof jack plug can be modified like FIG. 7b.

In this modified example, it is preferred that the male terminal body 42 has a plurality of spiral projections 44 formed on the outer circumferential surface thereof at its one side for increasing the fastening power with the jack terminal 11. The jack terminal 11 has a plurality of spiral grooves 15 formed on the inner circumferential surface thereof to be engaged with the spiral projections 44 of the male terminal body 42.

As such, since the jack plug and the jack terminal are engaged in a screw manner, the bolt torque is further increased and a further stabilized waterproof ability is provided.

Furthermore, in the battery casing having the charge/discharge multiple-use jack according to the present invention, an anti-overcharging unit 30 includes an anti-overcharging/overdischarging IC 32 mounted on a printed circuit board. The anti-overcharging/overdischarging IC 32 is connected to one terminal 6 of the battery through a sensor resistor R1 for sensing an overcharging or overdischarging state.

The other terminal 6′ of the battery is connected to two switches M1 and M2 serially connected each other, which are connected to the jack terminal 11. The two switches M1 and M2 are connected to the anti-overcharging/overdischarging IC 32 in parallel, so that they bypass the jack terminal 11.

The anti-overcharging/overdischarging circuit may include other kinds of known circuits. The present invention is not limited to the aforementioned circuit.

According to the present invention, as the charge/discharge multiple-use jack 10 constructed above is provided, charging and discharging can be performed through the same jack terminal. It makes the use of the charge/discharge multiple-use jack 10 very easy. As such, as the charging and discharging circuit are formed using the same jack, charging or discharging automatically occurs due to the potential of the battery and an external power through the jack terminal 11 or an electronic device.

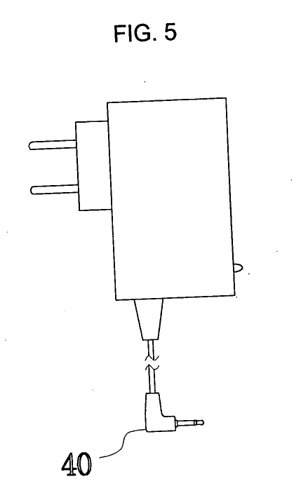

That is, if the jack plug connected to an electronic device is inserted into the charge/discharge multiple-use jack 10, the potential of the rechargeable battery 5 is high to generate discharging. Thus, current flows into the electronic device and serves as the power supply. In the event that the battery 5 is discharged, if a typical charger as shown in FIG. 5 is connected to the charge/discharge multiple-use jack 10, current flows into the battery 5 due to a high potential from the charger, so that the battery 5 is charged.

At this time, overcharging or overdischarging is prevented by the anti-overcharging unit. Accordingly, charging and discharging can be performed safely.

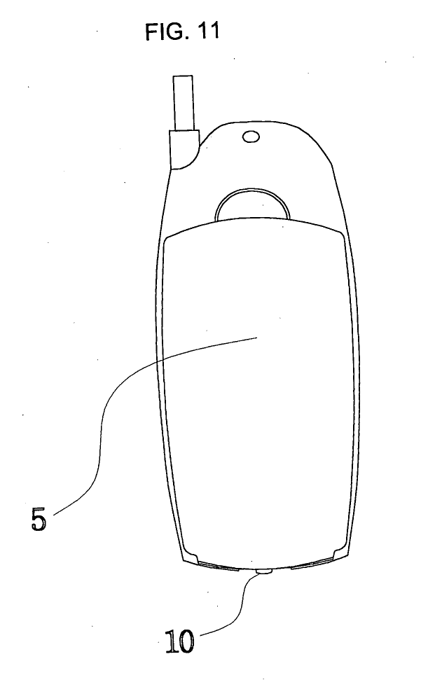

It is to be noted that the structure of the present invention is not applied to the battery casing only. The battery casing having the charge/discharge multiple-use jack according to the present invention can be also applied to a mobile phone as shown in FIG. 11.

A typical mobile phone usually serves as a battery casing for receiving the battery. Of course, a variety of transmit and receive components are also included in the mobile phone.

Such a typical mobile phone includes a port terminal that is engaged with a dedicated charger for charging the battery. Thus, the dedicated charger can be used only in the port terminal of the mobile phone.

Therefore, if it is required to urgently charge the mobile phone outside, it is impossible to charge the mobile phone without a dedicated charger.

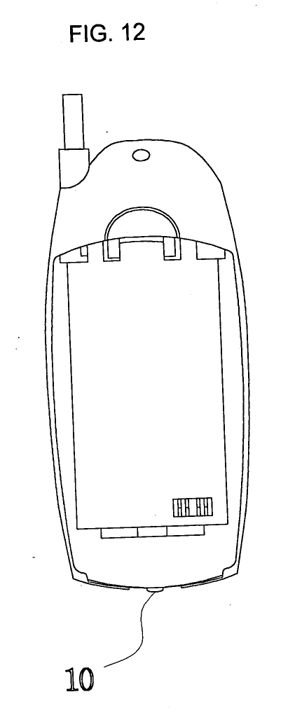

However, the problem can be solved according to the prevent invention as shown in FIG. 12. In other words, according to the present invention, in the battery casing having the charge/discharge multiple-use jack, the body casing has a structure in which the body casing becomes a body of a mobile phone, charging of the battery and discharging for the use of the mobile phone are performed in the mobile phone itself, and the battery is attached and detached to and from the mobile phone.

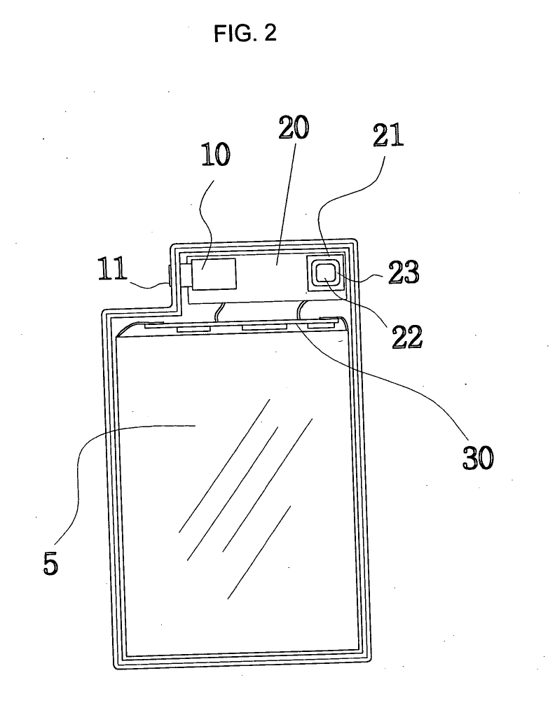

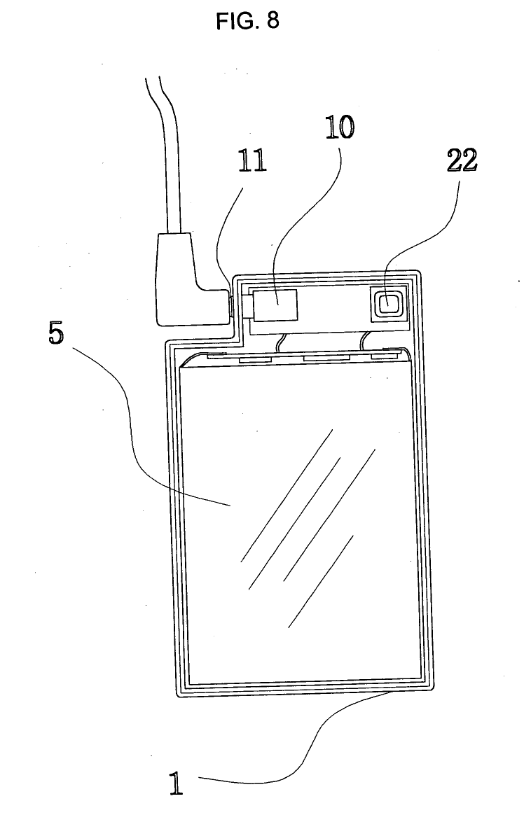

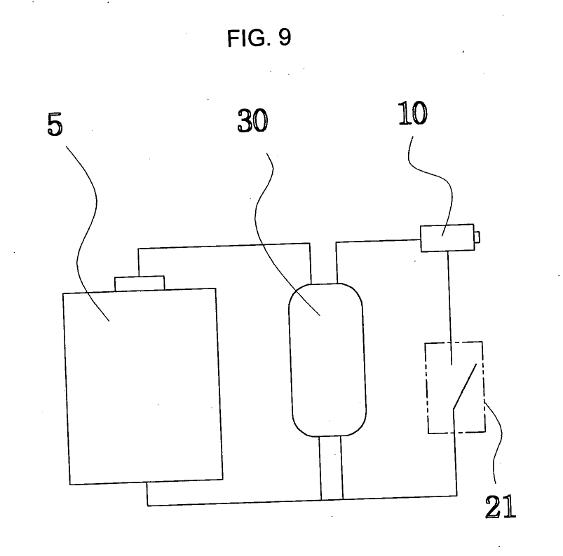

That is, in this embodiment, a body 1 of the mobile phone being the body casing 1 includes an input/output control unit 20 having a switching circuit, a battery 5, and an anti-overcharging unit 30 connected to the battery 5 and having an anti-overcharging circuit connected to the input/output control unit 20, as well as typical components of the mobile phone, as shown in FIG. 2 or FIG. 9. The input/output control unit 20 has the charge/discharge multiple-use jack 10 capable of performing both charging and discharging of the battery 5 as a single terminal.

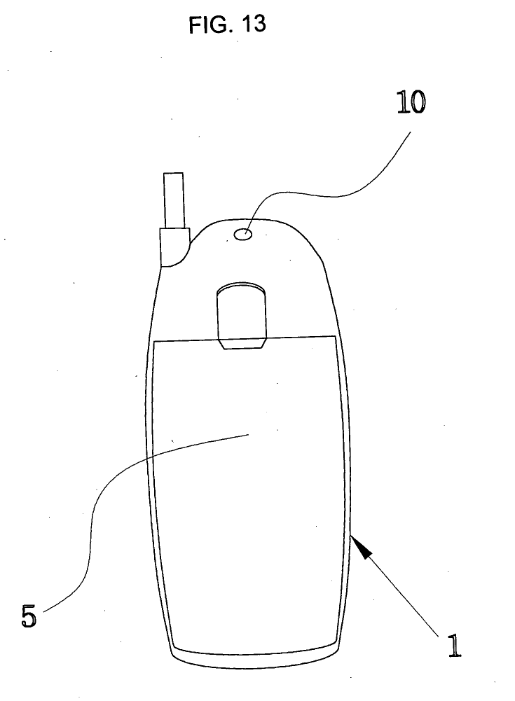

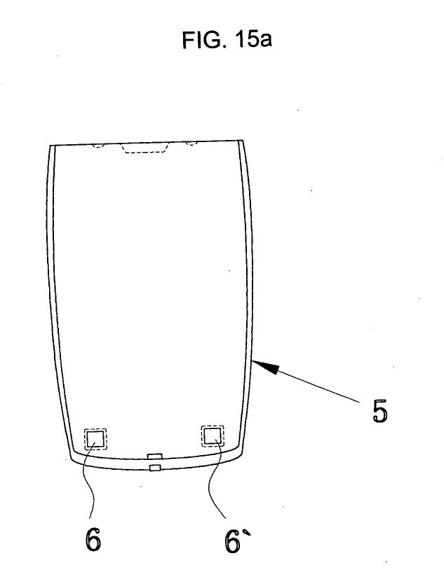

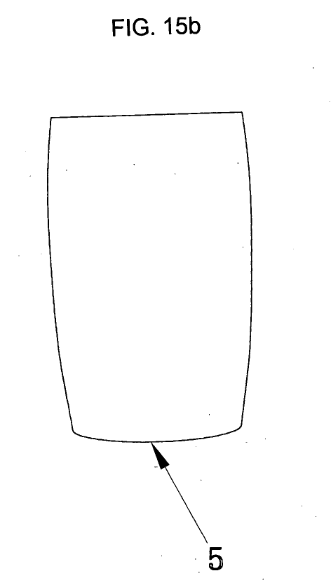

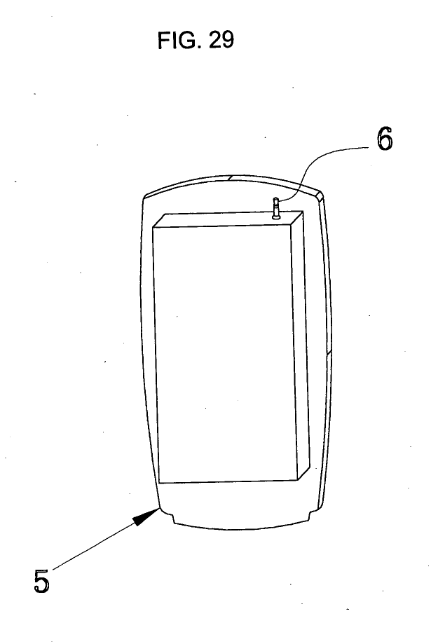

Of course, the battery 5 may be a typical kind that is used in a mobile phone, but may be a structure in which the terminals 6 and 6′ for inputting/outputting the power are formed only at the front, rear, top, bottom or side of the battery, as shown in FIG. 12, FIG. 13, FIG. 15a, FIG. 15b, FIG. 23 and FIG. 29.

In the present invention, the battery casing structure having the charge/discharge multiple-use jack is intact used in the body of the mobile phone.

That is, the input/output control unit or the anti-overcharging unit is disposed within the body of the mobile phone and an existing port jack for charging is replaced with a charge/discharge multiple-use jack 10.

The battery 5 of the mobile phone constructed above can be charged using any charger if their voltages are same. Thus, it is possible to obviate inconvenience that a user has to carry a charger everywhere. Further, the mobile phone can be used as an external power supply of an electronic device by connecting the device to the charge/discharge multiple-use jack 10 of the mobile phone.

A jack terminal guide hole is formed at one side of the body casing. The front end of the jack terminal 11 being the terminal of the charge/discharge multiple-use jack is located in the jack terminal guide hole. A space between the outer surface of the jack terminal and the jack terminal guide hole is tightly sealed with a filler for waterproof. Thereby, the structure as shown in FIG. 7a is obtained.

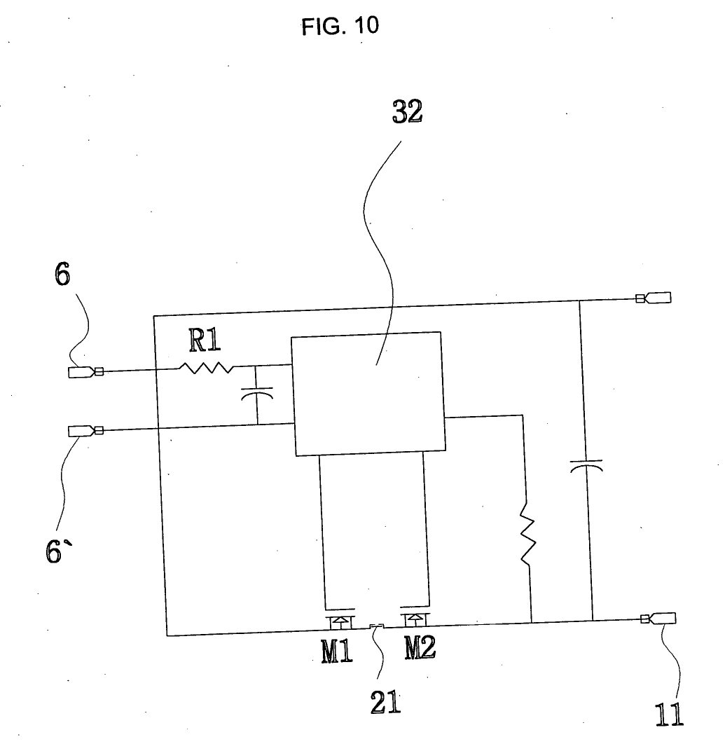

Furthermore, even in this embodiment, the anti-overcharging unit includes an anti-overcharging/overdischarging IC 32 mounted on a printed circuit board, as shown in FIG. 10. The anti-overcharging/overdischarging IC is connected to one terminal 6 of the battery through a sensor resistor R1 for sensing an overcharging or overdischarging state.

The other terminal 6′ of the battery is connected to two switches M1 and M2 serially connected each other, which are connected to the jack terminal 11. The two switches M1 and M2 are connected to the anti-overcharging/overdischarging IC 32 in parallel, so that they bypass the jack terminal 11.

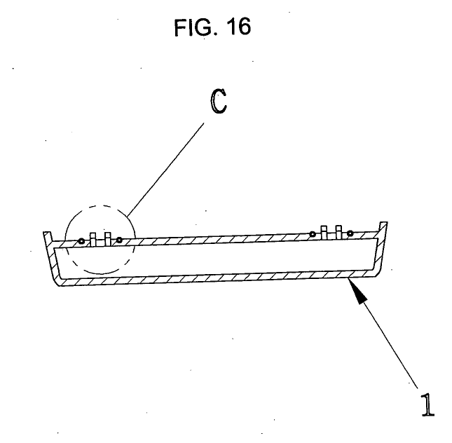

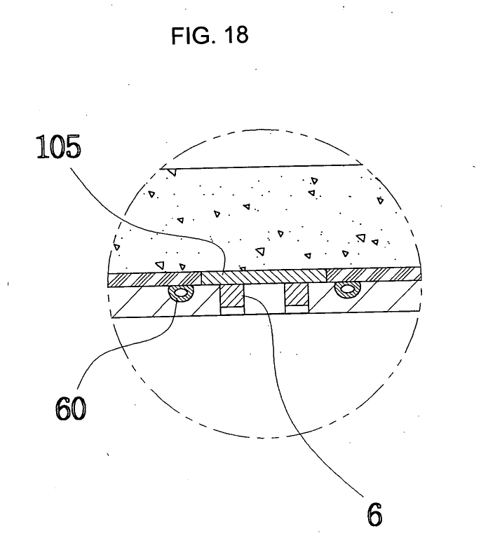

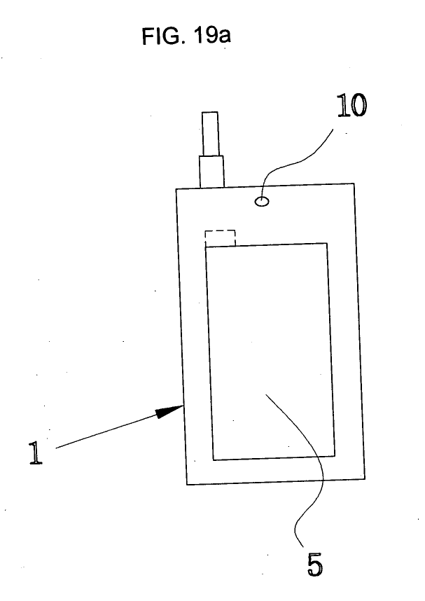

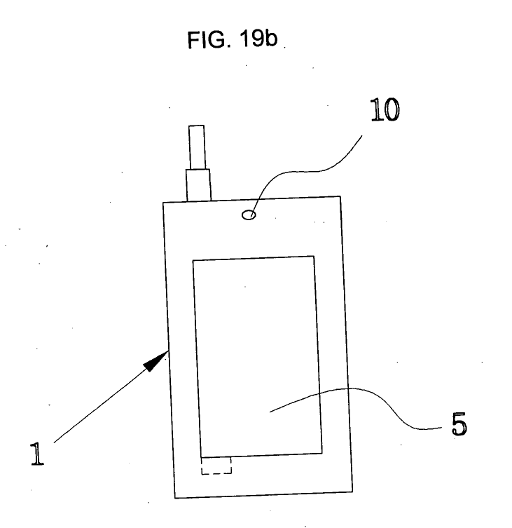

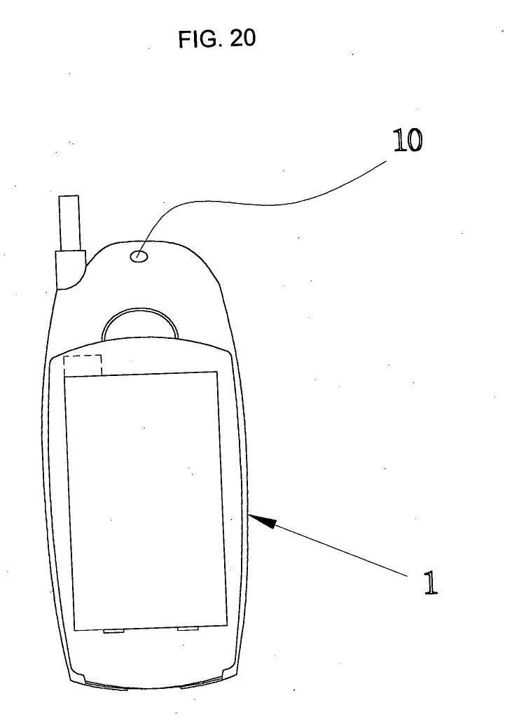

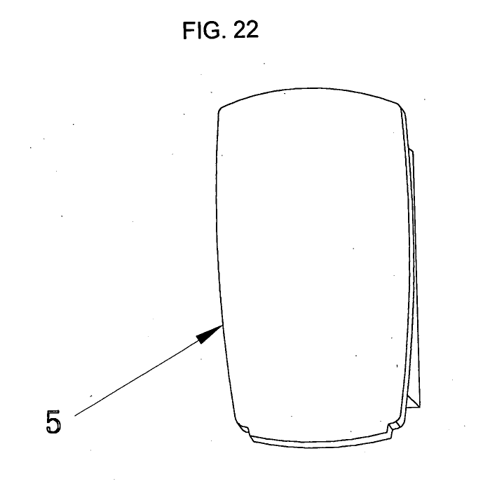

Further, in this embodiment, as shown in FIG. 13 to FIG. 31, the charge/discharge multiple-use jack 10 may be constructed so that it is used as an earphone jack.

To this end, a basic circuit shown in the FIG. 10 may be employed. At this time, the input/output control unit may include a jack separation circuit for automatically switching the terminal of the charge/discharge multiple-use jack to an earphone circuit or a charge/discharge circuit. The switching circuit for automatically switching the terminals is well known in the art. Thus, the detailed description on it will be omitted.

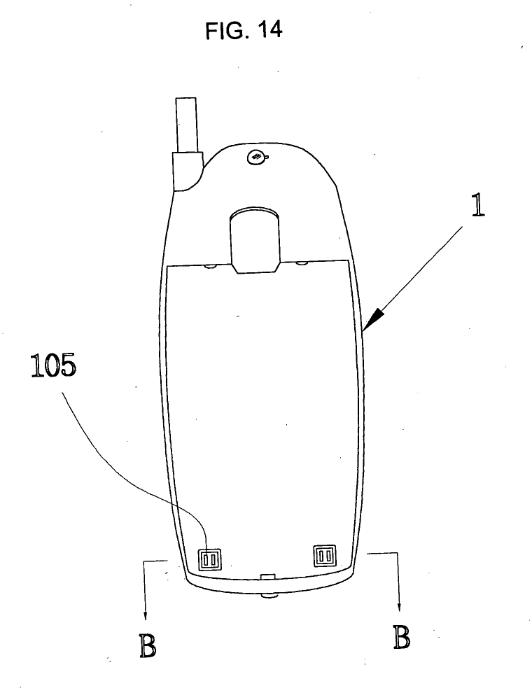

The terminals 6 and 6′ of the battery 5 used in this embodiment are constructed so that they are brought into contact with and electrically connected to a connecting jack 105 formed in the body casing 1 as in FIG. 14 to FIG. 29. A waterproof O-ring 60 is disposed in the connecting jack of the battery or around the connecting jack 105 of the body casing. When the terminals 6 and 6′ of the battery and the connecting jack 105 of the body casing are connected, the O-ring 60 tightly seals the connected portion.

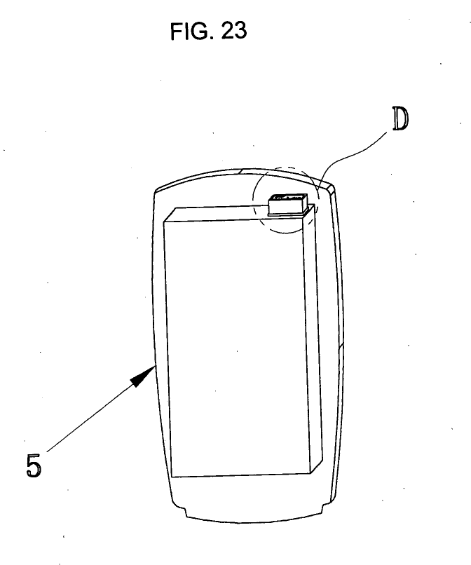

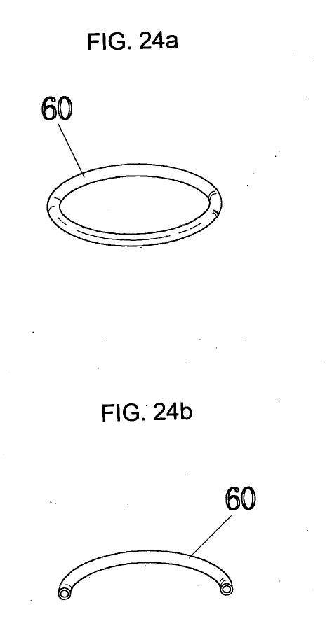

In order to further increase a waterproof effect of the terminal, it will be preferred that the O-ring 60 has a hollow ring shape having a hole formed therein, as shown in FIG. 24a and FIG. 24b, and is made using a material of a high elasticity.

The battery and the terminal structure of the body casing to be applied to this embodiment can be implemented in more detail in a variety of structures, as shown in FIG. 14 to FIG. 29.

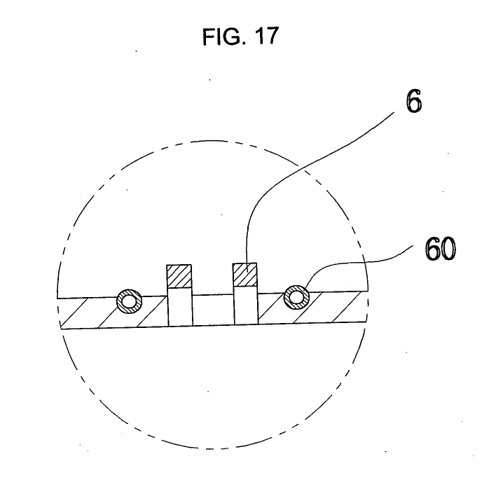

FIG. 14, FIG. 15a and FIG. 15b show modifications of a connecting jack structure of a battery in a typical mobile phone. In the above, the O-ring 60 for waterproof is disposed at the edge of the connecting jack 105 in an existing body casing. As shown in FIG. 17 and FIG. 18, if the battery is mounted in the body casing, the terminals 6 and 6′ of the battery and outer edges of the connecting jack 105 of the body casing are blocked from an outer atmosphere by means of the O-ring 60 for waterproof, so that the terminals are waterproofed.

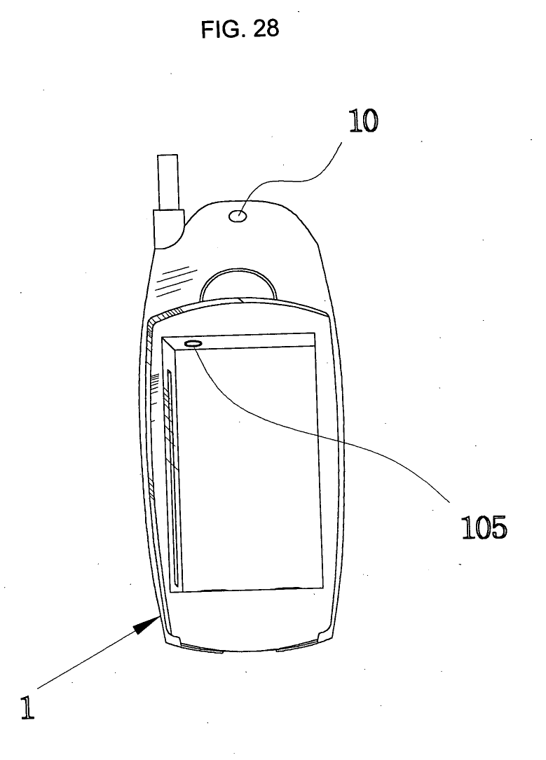

Furthermore, as shown in FIG. 28 and FIG. 29, the terminal 6 of the battery 5 may include a male terminal projected in a bar shape. The connecting jack 105 of the body casing 1 connected to the terminal 6 may include a female terminal depressed in a cylinder shape. This structure can be found in a structure that is usually used in a conventional earphone jack, etc.

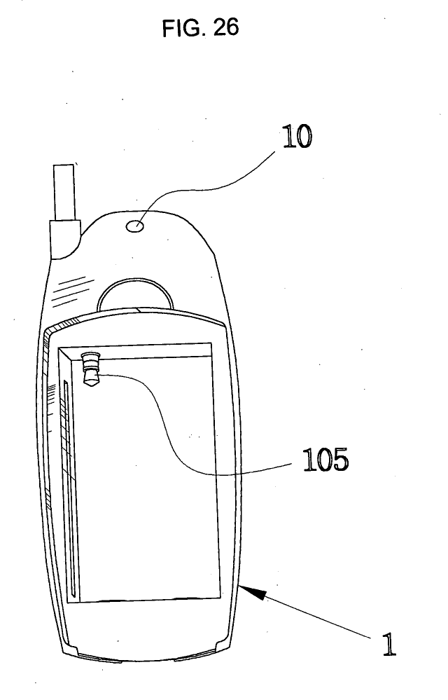

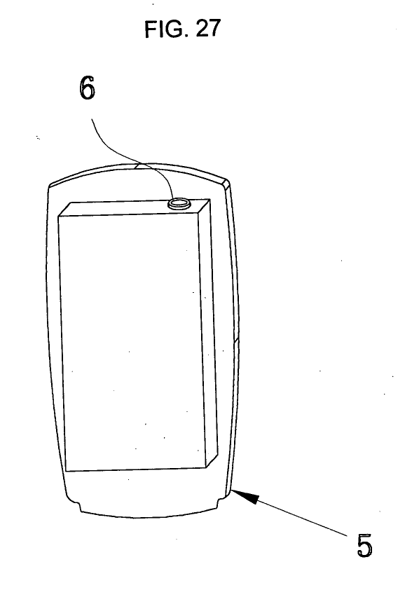

In addition, as shown in FIG. 26 and FIG. 27, the connecting jack 105 of the body casing 1 may include a male terminal projected in a bar shape. The terminal 6 of the battery 5 connected to the connecting jack 105 may include a female terminal depressed in a cylindrical shape.

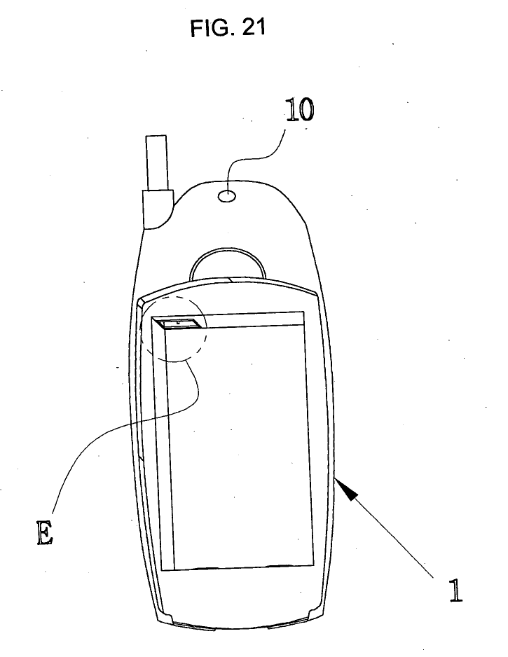

As shown in FIG. 21 to FIG. 25a, the terminal 6 of the battery 5 has a projected slim type male terminal of a thin cubic shape and the connecting jack 105 of the body casing 1 connected to the terminal 6 has a depressed female terminal having an inner surface corresponding to an outer surface of the male terminal.

This slim type male terminal has a structure in which an outer surface becomes one contact pole, its center has a hole formed therein and a contact point is formed within the hole. An insulating material is preferably filled between the outer surface and the hole.

The connecting jack 105 corresponding to the terminal 6 has a structure in which terminal contact points are formed on an inner wall of the connecting jack 105. Thus, if the terminal 6 is inserted into the connecting jack 105, it is brought into contact with the terminal contact points. A contact point bar that is inserted into the hole of the male terminal is also formed on an inner wall of the connecting jack 105.

As a modification of this structure, the shape of the terminals in the battery and the body casing may be changed. Detailed description on it will be omitted.

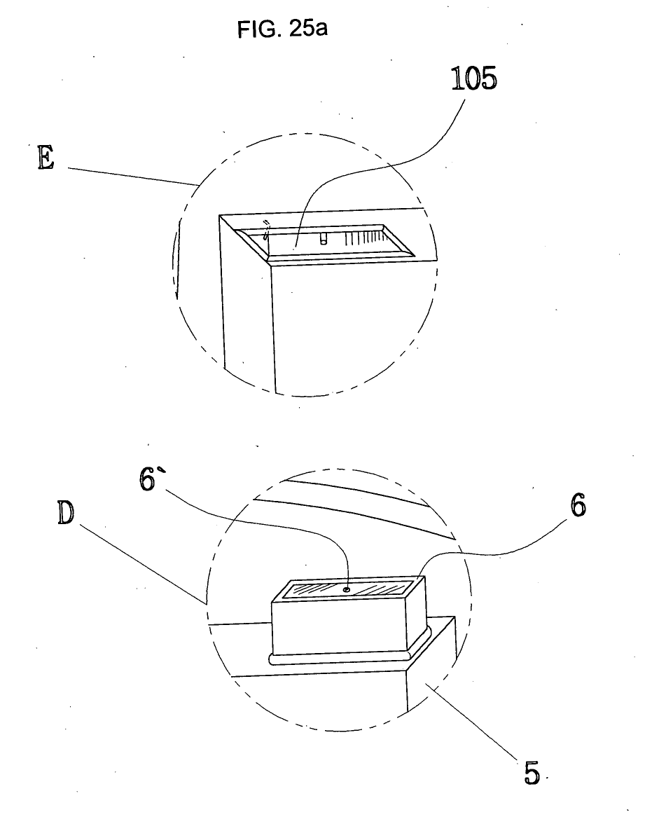

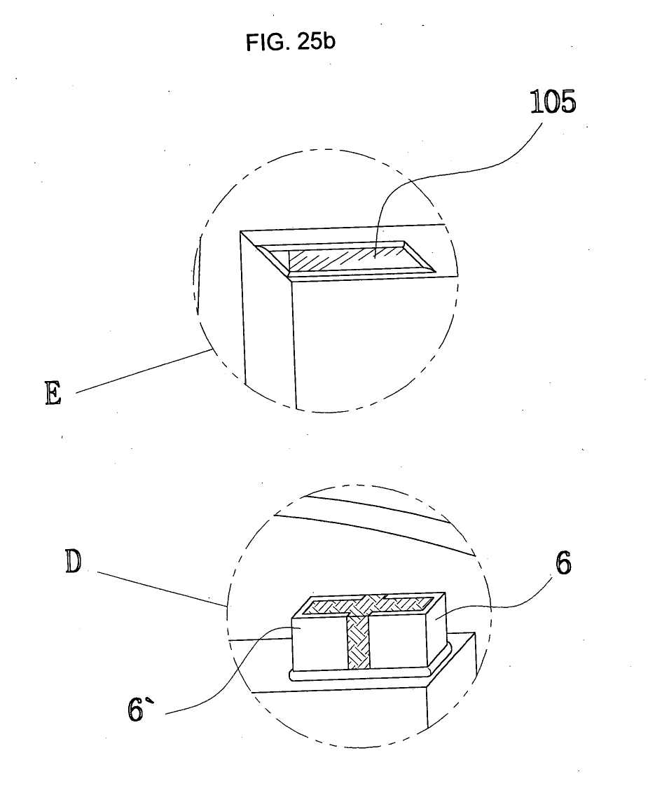

As a modification of FIG. 25a, a battery shown in FIG. 25b has the slim type terminal structure similar to that shown in FIG. 25a. In the above, the terminal 6 of the battery has a projected slim type terminal of a thin cubic shape having ground poles 67 and 68 formed at both sides in a lateral direction. The connecting jack 105 of the body casing connected to the terminal 6 has a depressed female terminal having an inner surface corresponding to an outer surface of the battery. It is preferable that both sides of the connecting jack of the battery and the ground pole are insulated with an insulating material.

Of course, on the contrary, the connecting jack of the body casing includes a projected slim type male terminal of a thin cubic shape having a ground pole formed each at its both sides in a lateral direction. The connecting jack of the battery connected to the male terminal may have a depressed female terminal having an inner surface corresponding to an outer surface of the connecting jack.

In the above embodiments, the O-ring 60 for waterproof is disposed between the terminal of the battery and the connecting jack of the body casing. A waterproof function is secured when the terminals are connected.

The terminal of the battery and the connecting jack of the body casing as in the aforementioned embodiments can be modified in a various manner.

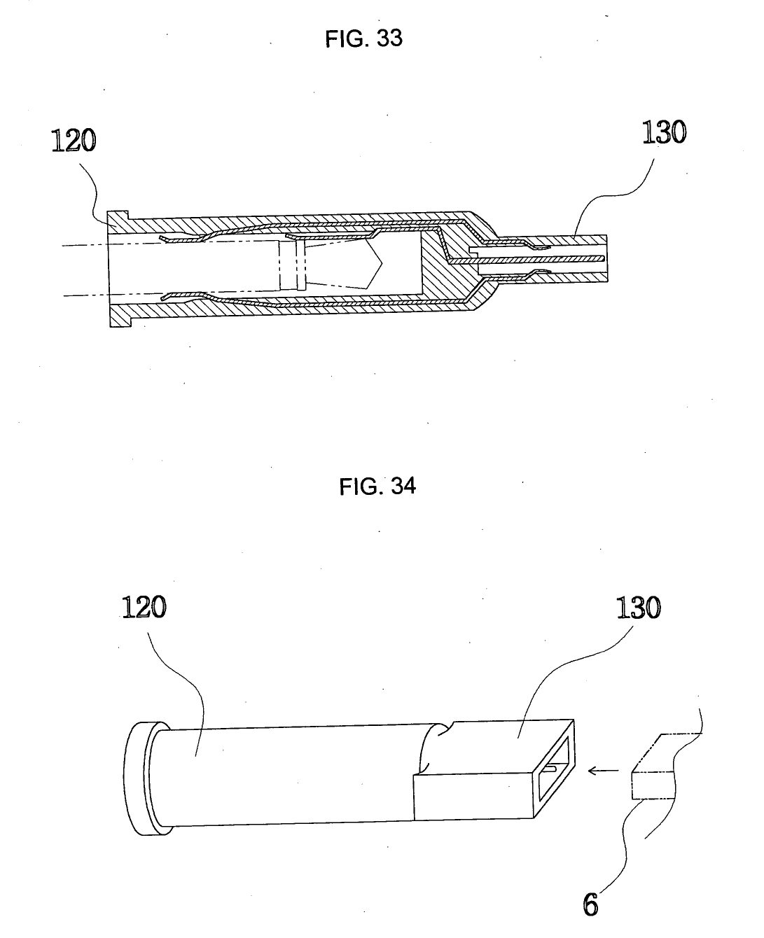

Also, the connecting jack of the battery having a variety of shapes according to the present invention can be connected to an additional external charger and the battery can be thus charged through an external charger. A relay terminal as shown in FIG. 33 and FIG. 34 may be used in order to relay the interconnection between a slim shape terminal of the battery as shown in FIG. 21 to FIG. 25b and a bar shape jack terminal of a common charger.

The relay terminal as shown in the drawings may have a bar shape connector 120 formed at one side thereof for connecting a bar shape male terminal to the bar shape connector, and a slim shape connector 130 formed at the other side thereof for connecting the slim shape terminal as shown in FIG. 21 to FIG. 25b to the slim shape connector. In this drawing, although only a case where the male terminal is inserted into the relay terminal has been described, a case where a female terminal is inserted into the relay terminal may be considered. In this case, the male and female structures will be interchanged. Description on them will be omitted.)

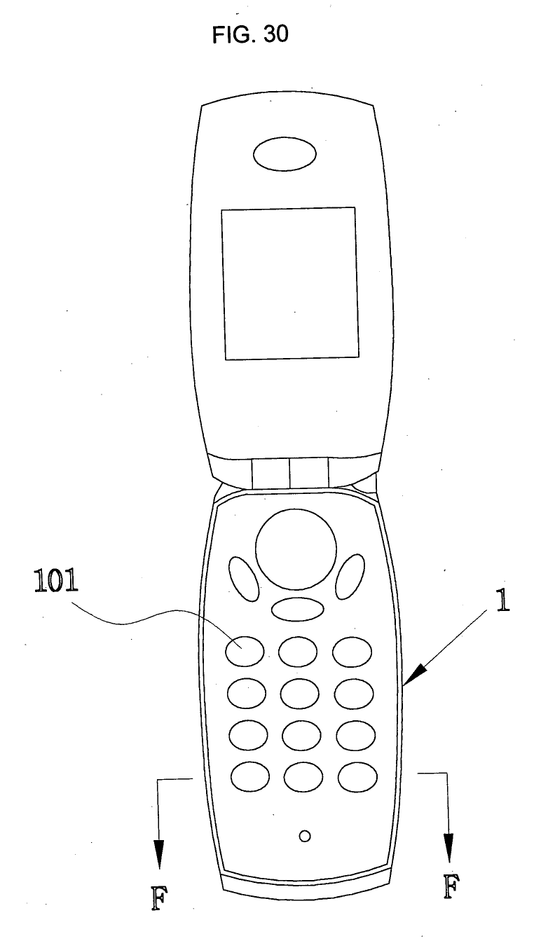

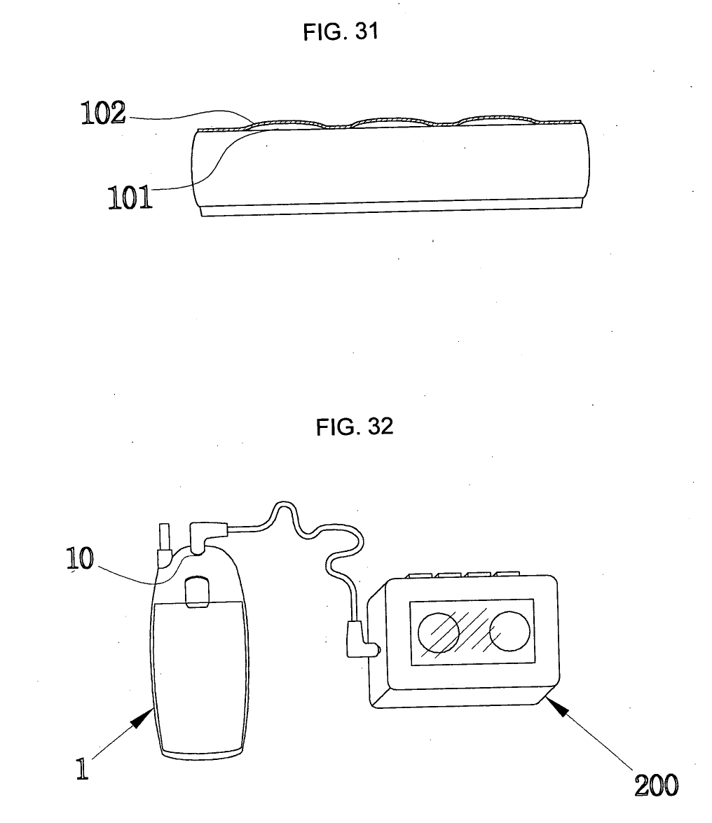

In the body casing according to the present invention, a waterproof sheet 102 for covering a plurality of buttons 101, which are protrudingly mounted at the front side of the body casing 1, may be attached to the front of the body casing, as shown in FIG. 30 and FIG. 31.

Such a waterproof sheet may be transparent or semi-transparent. It must be elastic enough to easily depress the buttons.

As such a waterproof sheet 102 is attached, it is possible to prevent water from infiltrating into the mobile phone through the buttons portion and to significantly increase the waterproof of the mobile phone.

As above, the mobile phone according to the present invention itself serves as the charger and the battery. In emergency, the mobile phone may serve as the power supply for supplying the power to other external electronic devices.

As an example, as shown in FIG. 32, a portable cassette recorder being an additional external device 200 can be operated using the power of a mobile phone, by connecting a portable cassette recorder to the jack terminal 11 of the charge/discharge multiple-use jack 10 in the mobile phone of the present invention through a jack code. At this time, a jack at the other side of the jack code connected to the charge/discharge multiple-use jack 10 of the mobile phone is connected to a power input jack of the portable cassette recorder.

Furthermore, the mobile phone according to the present invention can be used to simply charge other mobile phone. The mobile phone will be charged in the same manner as in the casing of the portable cassette recorder.

As described above, according to the present invention, since terminals for charging and discharging are integrated into a single terminal, it is very convenient to use the rechargeable battery. Further, since a complete waterproof structure is provided, the inventive rechargeable battery casing can be used as an external power supply of other electrical appliances that has to be used in a wet condition or in the water.

Furthermore, in the case where the inventive rechargeable battery casing is applied to a mobile phone, it can be used together with any adaptor only if the voltage is same. Thus, general-purpose charging is possible. the mobile phone to which the inventive battery casing is applied can be used as a separate charger or an external power supply.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A rechargeable battery casing structure having a charge/discharge multiple-use jack, comprising:
a body casing;
an input/output control unit disposed within the body casing and having a switching circuit;
a rechargeable battery located within the body casing; and
an anti-overcharging unit connected to the battery and having an anti-overcharging circuit connected to the input/output control unit,
wherein the input/output control unit has the charge/discharge multiple-use jack capable of performing both charging and discharging of the battery as a single terminal.

2. The rechargeable battery casing structure as claimed in claim 1,
wherein the input/output control unit has a pushing switch and the charge/discharge multiple-use jack mounted on a printed circuit board in which a switching circuit is formed, the pushing switch is formed such that a portion of a switch button is projected through a button projection hole formed in the body casing, and a waterproof cap for covering the top of the switch button is installed in such a manner that the waterproof cap tightly seals the button projection hole while resiliently pressing the button projection hole.

3. The rechargeable battery casing structure as claimed in claim 1, wherein the input/output control unit has a pushing switch and the charge/discharge multiple-use jack mounted on a printed circuit board in which a switching circuit is formed, the pushing switch is formed such that a portion of a switch button is projected through a button projection hole located in the body casing, and a waterproof cap for covering and tightly sealing the projected switch button and the button projection hole is disposed on an outer surface of the body casing.

4. The rechargeable battery casing structure as claimed in claim 1, wherein a jack terminal guide hole is formed at one side of the body casing so that the front end of the jack terminal as the terminal of the charge/discharge multiple-use jack is projected toward the outside through the jack terminal guide hole, and a space between the outer surface of the jack terminal and the jack terminal guide hole is tightly sealed with a filler for waterproof.

5. The rechargeable battery casing structure as claimed in claim 1, wherein the anti-overcharging unit comprises an anti-overcharging/overdischarging IC mounted on a printed circuit board, the anti-overcharging/overdischarging IC being connected to one connecting jack of the battery through a sensor resistor for sensing an overcharging or overdischarging state, and the other connecting jack of the battery is connected to two switches serially connected to each other to be connected to the jack terminal, the two switches being connected to the anti-overcharging/overdischarging IC in parallel to bypass the jack terminal.

6. The rechargeable battery casing structure as claimed in claim 1, wherein the body casing has a structure in which the body casing becomes a body of a mobile phone, charging of the battery and discharging for the use of the mobile phone are performed in the mobile phone itself, and the battery is adapted to be attached and detached to and from the mobile phone.

7. The rechargeable battery casing structure as claimed in claim 6, wherein a jack terminal guide hole is formed at one side of the body casing so that the front end of the jack terminal as the terminal of the charge/discharge multiple-use jack is located in the jack terminal guide hole, and a space between the outer surface of the jack terminal and the jack terminal guide hole is tightly sealed with a filler for waterproof.

8. The battery casing structure as claimed in claim 6, wherein the anti-overcharging unit comprises an anti-overcharging/overdischarging IC mounted on a printed circuit board, the anti-overcharging/overdischarging IC being connected to one connecting jack of the battery through a sensor resistor for sensing an overcharging or overdischarging state, and the other connecting jack of the battery is connected to two switches serially connected to each other to be connected to the jack terminal, the two switches being connected to the anti-overcharging/overdischarging IC in parallel to bypass the jack terminal.

9. The battery casing structure as claimed in claim 6, wherein the charge/discharge multiple-use jack is also used as an earphone jack.

10. The battery casing structure as claimed in claim 9, wherein the input/output control unit includes a jack separation circuit for automatically switching the terminal of the charge/discharge multiple-use jack to an earphone circuit or a charge/discharge circuit.

11. The battery casing structure as claimed in claim 6, wherein the terminals of the battery are brought into contact with and electrically connected to a connecting jack formed in the body casing, and an O-ring for waterproof is disposed in the connecting jack of the battery or around the connecting jack of the body casing, so that when the terminals of the battery and the connecting jack of the body casing are connected to each other, the O-ring tightly seals the connected portion.

12. The battery casing structure as claimed in claim 7, wherein a connecting jack of the battery comprises a male terminal projected in a bar shape, and a connecting jack of the body casing connected to the connecting jack of the battery is formed as a female terminal depressed in a cylinder shape.

13. The battery casing structure as claimed in claim 7, wherein a terminal of the body casing comprises a male terminal projected in a bar shape, and a connecting jack of the battery connected to the terminal of the body casing is formed as a female terminal depressed in a cylinder shape.

14. The battery casing structure as claimed in claim 7, wherein a connecting jack of the battery comprises a projected slim type male terminal of a thin cubic shape having a ground pole formed each at its both sides in a lateral direction, and a terminal of the body casing connected to the male terminal comprises a depressed female terminal having an inner surface corresponding to an outer surface of the connecting jack.

15. The battery casing structure as claimed in claim 7, wherein a terminal of the body casing comprises a projected slim type male terminal of a thin cubic shape having a ground pole formed each at its both sides in a lateral direction, and a connecting jack of the body casing connected to the male terminal comprises a depressed female terminal having an inner surface corresponding to an outer surface of the male terminal.

16. The battery casing structure as claimed in claim 7, wherein a waterproof sheet for covering a plurality of buttons protrudingly mounted at the front of the body casing is attached to the front of the body casing.

17. A jack connecting member, wherein the jack connecting member comprises a cylindrical shape male terminal into which a bar shape male terminal is inserted, at its one side, so that the projected slim shape male terminal according to claim 14 and a terminal of an external adaptor are connected to each other, and a female terminal having an inner surface corresponding to an outer surface of the projected slim shape male terminal, at its the other side, so that the projected slim shape male terminal can be inserted into the female terminal.

18. A waterproof jack plug having a jack plug unit wherein one end of an electric code is connected to a typical electrical appliance and the other end of the electric code is inserted into a jack terminal of the charge/discharge multiple-use jack according to claim 4,
wherein the jack plug unit comprises:
a male terminal body having a plurality of contacts formed at its one end, wherein the contacts serve as electrodes and the male terminal is inserted into the jack terminal; and
a plug body for housing the other end of the male terminal connected to the electric code of the male terminal body,
wherein the male terminal body has a waterproof packing of a resilient material formed at the outer circumferential surface thereof at its one side for blocking and tightly sealing a space between the jack terminal and the male terminal body when the male terminal body is inserted into the jack terminal.

19. The waterproof jack plug as claimed in claim 18, wherein the male terminal body has a plurality of spiral projections formed at an outer circumferential surface thereof at its one side for increasing the fastening power with the jack terminal.

20. A relay terminal which includes a bar shape connector 120 formed at one side thereof for connecting a bar shape male terminal to the bar shape connector, and a slim shape connector 130 formed at the other side thereof for connecting a slim shape terminal of a rechargeable battery to the slim shape connector, in order to relay interconnection between the slim shape terminal and a bar shape jack terminal of a common charger.
